(19) United States
(12) Patent Application Publication
(10) Pub. No.: US 2014/0328232 A1
(43) Pub. Date: Nov. 6, 2014

(54) METHOD AND APPARATUS FOR ENABLING PACKET BASED COMMUNICATIONS INITIATED THROUGH CIRCUIT SWTICHED SIGNALING MESSAGES

(71) Applicant: QUALCOMM INCORPORATED, San Diego, CA (US)

(72) Inventor: Mohammed Ataur Rahman Shuman, San Diego, CA (US)

(73) Assignee: QUALCOMM Incorporated, San Diego, CA (US)

(21) Appl. No.: 13/874,987

(22) Filed: May 1, 2013

(51) Int. Cl. H04W 52/02; H04W 76/02

(52) U.S. Cl. CPC H04W 52/0229; H04W 76/02
USPC 370/311

(57) ABSTRACT

A method, an apparatus, and a computer program product for wireless communication are provided in connection with establishment of packet based communications through use of circuit switched signaling messages. In one example, a communications device is equipped to receive, by a circuit switched (CS) interface associated with a target device, a first CS signaling message from an originator device, determine whether to initiate the packet data session in response to receipt of the first CS signaling message, and establishing, using a packet switched (PS) interface associated with the target device, an internet protocol (IP) communication session in response to communication of an IP connection request between the originator device and the target device upon a determination to initiate the packet data session. In an aspect, the first CS signaling message may include an indication prompting the target device to initiate a packet data session.

### BACKGROUND

1. Field

The present disclosure relates generally to communication systems, and more particularly, to a system and method enabling establishment of packet based communications through use of circuit switched signaling messages.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access through improved spectral efficiency, lower costs, improved services, use of new spectrum, and better integration with other open standards using OFDMA on the downlink (DL), SC-FDMA on the uplink (UL), and multiple-input multiple-output (MIMO) antenna technology.

Use of internet protocol (IP) based (e.g., packet based) communication between multiple devices (e.g., smartphones, tablets, handheld gaming devices, etc.) over Cellular 2G, 3G and 4G networks is a growing trend. Such communications facilitate near instant communication among end users regardless of whether the user is receiving service from different wireless operators and/or over different radio access technologies (e.g., 3G vs. 4G). To support continuous IP based communications between multiple devices, each of the devices providing would maintain an “ON” packet data connection. Maintaining such an “ON” condition may result in excess power usage for a user device, excessive resource usage for the network, etc. Conversely, when a user device does not maintain an “ON” packet data connection, then the user may not be reachable for internet protocol (IP) based communications.

As such, a system and method that allows a user device to experiences an always “ON” IP communication without requiring always ON cellular packet data service may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with establishment of packet based communications through use of circuit switched signaling messages. In one example, a communications device is equipped to receive, by a circuit switched (CS) interface associated with a target device, a first CS signaling message from an originator device, determine whether to initiate the packet data session in response to receipt of the first CS signaling message, and establishing, using a packet switched (PS) interface associated with the target device, an internet protocol (IP) communication session in response to communication of an IP connection request between the originator device and the target device upon a determination to initiate the packet data session. In an aspect, the first CS signaling message includes an indication prompting the target device to initiate a packet data session. In another aspect, a communications device may be equipped to receiving, internally from an application associated with an originator device, a request to establish an IP communication session with a target device, determine whether the target device has an active packet data session set up, and transmit, by a CS interface associated with the originator device, a first CS signaling message. In an aspect, the first CS signaling message may include an indication prompting the target device to initiate the packet data session upon a determination that the target device does not have the active packet data session set up, that the originator device is unable to determine that the target device has the active packet data session set up, etc.

According to a related aspect, a method for establishing packet based communications through use of circuit switched signaling messages is provided. The method can include receiving, by a CS interface associated with a target device, a first CS signaling message from an originator device. In an aspect, the first CS signaling message may include an indication prompting the target device to initiate a packet data session. Further, the method can include determining whether to initiate the packet data session in response to receipt of the first CS signaling message. Moreover, the method may include establishing, using a PS interface associated with the target device, an IP communication session in response to communication of an IP connection request between the originator device and the target device upon a determination to initiate the packet data session.

Another aspect relates to a communications apparatus enabled to establishment of packet based communications through use of circuit switched signaling messages. The communications apparatus can include means for receiving, by a CS interface associated with a target device, a first CS signaling message from an originator device. In an aspect, the first CS signaling message may include an indication prompting the target device to initiate a packet data session. Further, the communications apparatus can include means for determining whether to initiate the packet data session in response to receipt of the first CS signaling message. Moreover, the communications apparatus can include means for establishing, using a PS interface associated with the target device, an IP communication session in response to communication of an IP connection request between the originator device and the target device upon a determination to initiate the packet data session.

Another aspect relates to a communications apparatus. The apparatus can include a processing system configured to receive, by a CS interface associated with a target device, a first CS signaling message from an originator device. In an aspect, the first CS signaling message may include an indication prompting the target device to initiate a packet data session. Further, the processing system may be configured to determine whether to initiate the packet data session in response to receipt of the first CS signaling message. Moreover, the processing system may further be configured to establish, using a PS interface associated with the target device, an IP communication session in response to communication of an IP connection request between the originator device and the target device upon a determination to initiate the packet data session.

Still another aspect relates to a computer program product, which can have a computer-readable medium including code for receiving, by a CS interface associated with a target device, a first CS signaling message from an originator device. In an aspect, the first CS signaling message may include an indication prompting the target device to initiate a packet data session. Further, the computer-readable medium may include code for determining whether to initiate the packet data session in response to receipt of the first CS signaling message. Moreover, the computer-readable medium can include code for establishing, using a PS interface associated with the target device, an IP communication session in response to communication of an IP connection request between the originator device and the target device upon a determination to initiate the packet data session.

According to another related aspect, a method for establishing packet based communications through use of circuit switched signaling messages is provided. The method can include receiving, internally from an application associated with an originator device, a request to establish an IP communication session with a target device. Further, the method can include determining whether the target device has an active packet data session set up. Moreover, the method may include transmitting, by a CS interface associated with the originator device, a first CS signaling message. In an aspect, the first CS signaling message may include an indication prompting the target device to initiate a packet data session upon a determination either that the target device does not have the active packet data session set up or that the originator device is unable to determine that the target device has the active packet data session set up.

Another aspect relates to a communications apparatus enabled to establishment of packet based communications through use of circuit switched signaling messages. The communications apparatus can include means for receiving, internally from an application associated with an originator device, a request to establish an IP communication session with a target device. Further, the communications apparatus can include means for determining whether the target device has an active packet data session set up. Moreover, the communications apparatus can include means for transmitting, by a CS interface associated with the originator device, a first CS signaling message. In an aspect, the first CS signaling message may include an indication prompting the target device to initiate a packet data session upon a determination either that the target device does not have the active packet data session set up or that the originator device is unable to determine that the target device has the active packet data session set up.

Another aspect relates to a communications apparatus. The apparatus can include a processing system configured to receive, internally from an application associated with an originator device, a request to establish an IP communication session with a target device. Further, the processing system may be configured to determine whether the target device has an active packet data session set up. Moreover, the processing system may further be configured to transmit, by a CS interface associated with the originator device, a first CS signaling message. In an aspect, the first CS signaling message may include an indication prompting the target device to initiate a packet data session upon a determination either that the target device does not have the active packet data session set up or that the originator device is unable to determine that the target device has the active packet data session set up.

Still another aspect relates to a computer program product, which can have a computer-readable medium including code for receiving, internally from an application associated with a originator device, a request to establish an IP communication session with a target device. Further, the computer-readable medium may include code for determining whether the target device has an active packet data session set up. Moreover, the computer-readable medium can include code for transmitting, by a CS interface associated with the originator device, a first CS signaling message. In an aspect, the first CS signaling message may include an indication prompting the target device to initiate a packet data session upon a determination either that the target device does not have the active packet data session set up or that the originator device is unable to determine that the target device has the active packet data session set up.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a network architecture;

FIG. 2 is a diagram illustrating an example of an access network;

FIG. 3 is a diagram illustrating another example of an access network according to an aspect;

FIG. 4 is a call flow diagram describing interactions between multiple devices in a communications network, according to an aspect;

FIG. 5 is a flow chart of a first method of wireless communication, according to an aspect;

FIG. 6 is a flow chart of a second method of wireless communication, according to an aspect;

FIG. 7 is a block diagram example architecture of a communications device, according to an aspect; and

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

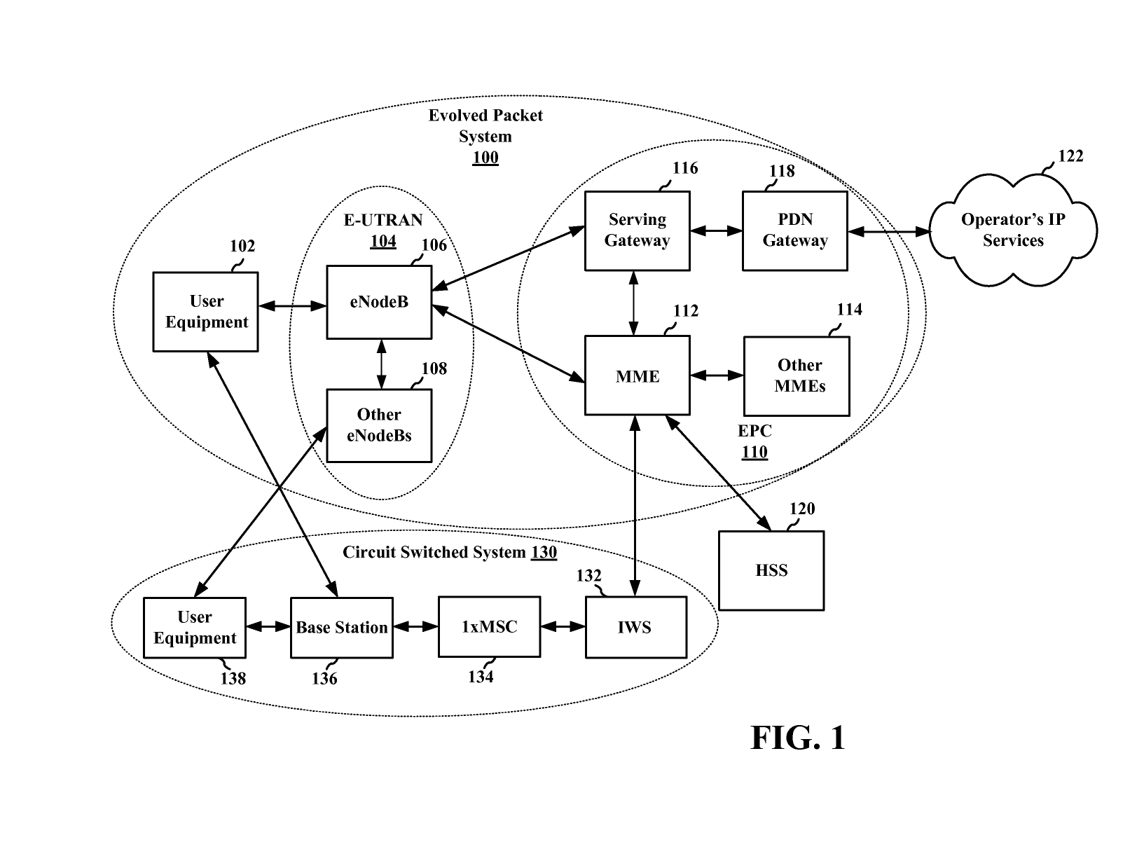

FIG. 1 is a diagram illustrating an access network that is configured to support at least an Evolved Packet System (EPS) architecture 100 and a circuit switched (CS) system 130.

The EPS 100 may include one or more user equipments (UEs) 102, 138, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, such as a circuit switched system 130. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user plane and control plane protocol terminations toward the UEs 102, 138. The eNB 106 may be connected to the other eNBs 108 via an X2 interface (i.e., backhaul). The eNB 106 may also be referred to by those skilled in the art as a base station, a base transceiver station, a radio base station, a radio transceiver, a transceiver function, a basic service set (BSS), an extended service set (ESS), or some other suitable terminology. The eNB 106 provides an access point to the EPC 110 for a UEs 102, 138. Examples of UEs 102, 138 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102, 138 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an 51 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102, 138 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 include the Internet, the Intranet, an IP Multimedia Subsystem (IMS), and a PS Streaming Service (PSS).

The circuit switched system 130 includes an interworking solution (IWS) 132, a mobility switching center (MSC) 134, a base station 136, and one or more UEs 102, 138. In an aspect, circuit switched system 130 may communicate with EPS 100 through the IWS 132 and MME 112.

Generally, UEs 102, 138 that have an active packet data session in EPS 100 can receive and send IP based communications with other UEs 102, 138 that have an active packet data session, Operator's IP Services 122. Where the UEs 102, 138 do not have an active packet data session, then the UEs 102, 138 may not communicate to IP based communications. Further, UEs 102, 138 may be configured to perform CS calls, communicate short message service (SMS) messages, etc., through circuit switched system 130. In an aspect, service options may be used in the circuit switched system 130 messages to indicate which service is to be provided. Examples of currently use service options are provided in Table 1 below.

TABLE 1
CS message service options

| Service Option | Description |
|---|---|
| SO1 (Voice) | Basic Variable Rate Voice Service (8 kbps) |
| SO3 (Voice) | Enhanced Variable Rate Codec (EVRC) Voice |
| | Service (8 kbps) |
| SO6 (SMS) | Short Message Services (Rate Set 1) |
| SO9 (Loopback) | Mobile Station Loopback (13 kbps) |
| SO14 (SMS) | Short Message Services (Rate Set 2) |
| SO17 (Voice) | High Rate Voice Service (13 kbps) |
| SO32 (+F-SCH) | Test Data Service Option (TDSO) |
| SO32 (+SCH) | Test Data Service Option (TDSO) |
| SO33 * | cdma2000 High Speed Packet Data Service, |
| | Internet or ISO Protocol Stack |
| SO33 (+F-SCH) * | cdma2000 High Speed Packet Data Service, |
| | Internet or ISO Protocol Stack |
| SO55 (Loopback) | Loopback Service Option (LSO) |

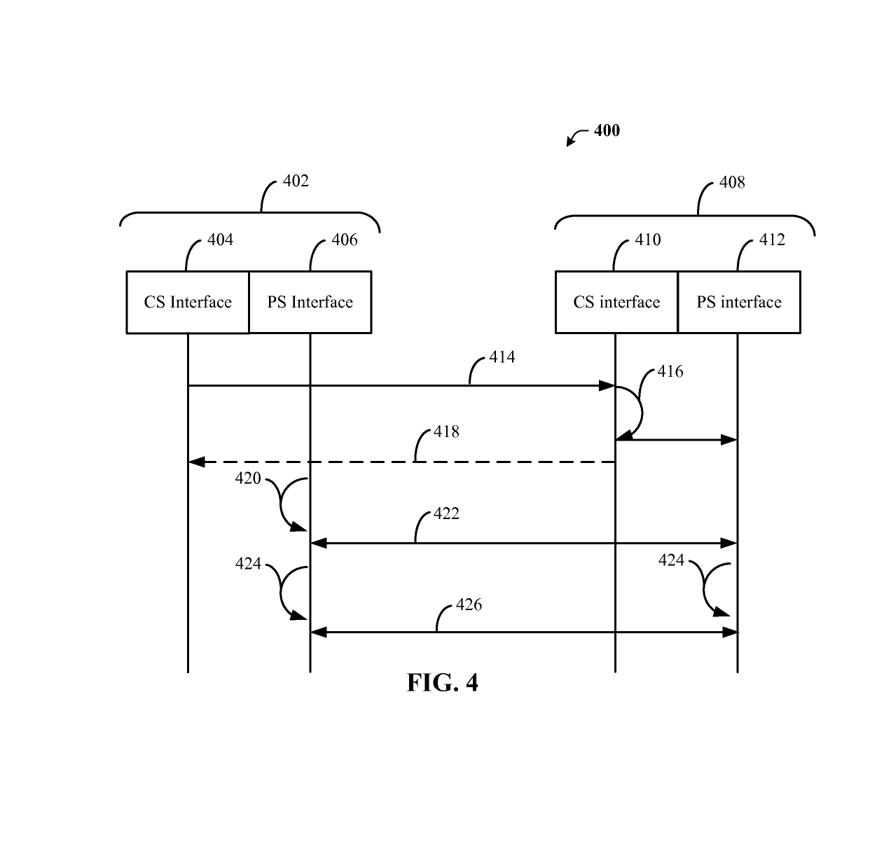

As noted above, where a UE 102, 138 is not actively connected (e.g., not “ON”) to the EPS 100, the UEs may not perform IP based communications with each other, via the EPs 100. Each UE 102, 138 may be able to communicate with the circuit switched system 130 through CS signaling messages without maintaining an active session. Various schemes are discussed in detail with respect to FIGS. 4-6 to that allow UEs 102, 138 to experiences an always “ON” IP communication without having always ON cellular packet data service through use of CS signaling messages.

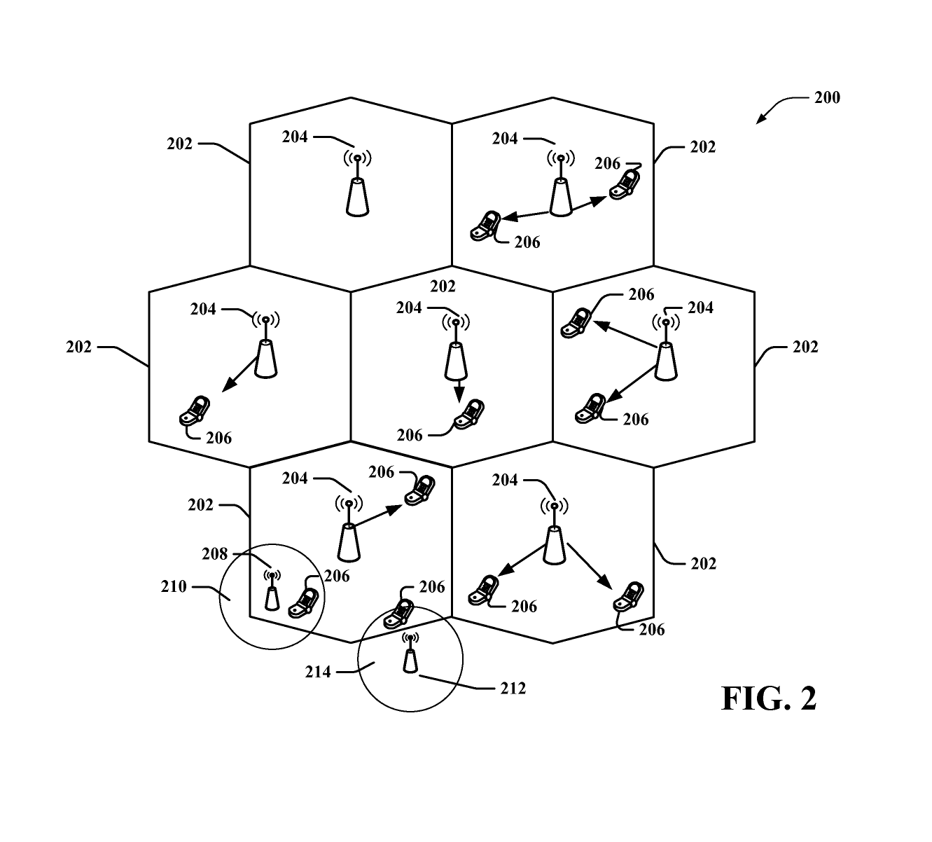

FIG. 2 is a diagram illustrating an example of an access network in an LTE network architecture. In this example, the access network 200 is divided into a number of cellular regions (cells) 202. One or more lower power class eNBs 208, 212 may have cellular regions 210, 214, respectively, that overlap with one or more of the cells 202. The lower power class eNBs 208, 212 may be femto cells (e.g., home eNBs (HeNBs)), pico cells, or micro cells. A higher power class or macro eNB 204 is assigned to a cell 202 and is configured to provide an access point to the EPC 110 for all the UEs 206 in the cell 202. There is no centralized controller in this example of an access network 300, but a centralized controller may be used in alternative configurations. The eNB 204 is responsible for all radio related functions including radio bearer control, admission control, mobility control, scheduling, security, and connectivity to the serving gateway 116 (see FIG. 1).

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNB 204 may have multiple antennas supporting MIMO technology. The use of MIMO technology enables the eNB 204 to exploit the spatial domain to support spatial multiplexing, beamforming, and transmit diversity.

Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the downlink. The spatially precoded data streams arrive at the UE(s) 206 with different spatial signatures, which enables each of the UE(s) 206 to recover the one or more data streams destined for that UE 206. On the uplink, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PAPR).

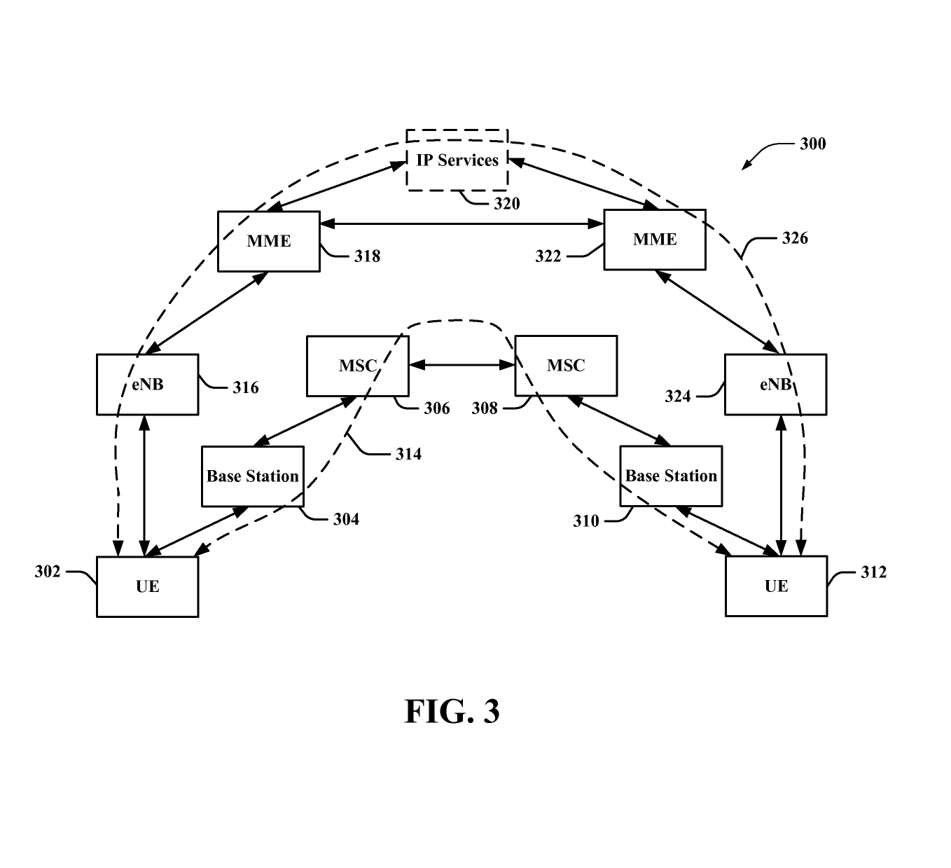

FIG. 3 is a diagram illustrating an example of an access network 300 in which a CS signaling message may be communicated between UEs to prompt the UEs to engage in IP based communications.

In an operational aspect, UE 302 may transmit a CS signaling message 314 identifying UE 312 as a target device. FIG. 3 depicts an example path the CS signaling message 314 may be communicated upon according to an aspect. CS signaling message 314 may be communicated to base station 304 serving the first UE 302, then to a MSC 306 serving the first UE 302, then to a MSC 308 serving the second UE 312, then to a base station 310 serving the second UE 312, and then to the second UE 312. In an aspect, although depicted as separate base stations (304, 310) and MSCs (306, 308), the UEs may be served by the same base station (304, 310) and/or same MSC (306, 308). Once UE 312 receives and processes the CS signaling message 314, the UE 312 may determine whether to provide no response, to respond by initiating a CS call, to respond by indicating that the UE 312 is unavailable for IP based communications, or respond with a CS signaling message 314 prompting the first UE 302 to initiate a packet data session.

In an operational aspect in which UE 312 is able to support a packet data session, the UEs 302, 312 may establish data packet sessions through a packet based access system (e.g., EPC 110). Once an IP communication session is established between UEs 302 and 312, the UEs 302 and 312 may perform IP based communications 326. FIG. 3 depicts an example path the IP based communications 326 may be communicated upon according to an aspect. IP based communications 326 may be communicated to eNB 316 serving the first UE 302, then to a MME 318 serving the first UE 302, then to a MME 322 serving the second UE 312, then to a eNB 324 serving the second UE 312, and then to the second UE 312. In an optional aspect, the IP based communications 326 may also be communicated via an Operator's IP services 320. In an aspect, although depicted as separate eNBs (316, 324) and MMEs (318, 322), the UEs may be served by the same eNB (316, 324) and/or same MME (318, 322).

Further discussion on various communications between the UEs 302 and 312 via CS signaling messages 314 and IP based communications 326 are provided with reference to FIGS. 4-6.

FIGS. 4, 5, and 6 illustrate various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Generally, with respect to FIGS. 4-6, communications between a UE and an eNB may be supported using an LTE RAT with uplink and downlink information transfer. Further, communications between the eNB and a MME may be supported through an S1 interface and may provide for S1 cdma2000 tunneling.

FIG. 4 depicts an example call-flow diagram for interactions between multiple devices (402, 408) in a communications network 400 (e.g., cellular network configured to support IP communications). Each device (402, 408) may include a circuit switched (CS) interface (404, 410) and a packet switched (PS) interface (406, 412).

At act 414, a first device 402 may determine that a second device 408 (e.g., target device) may not have an active (“ON”) packet data session, and send a CS signaling message that includes an indication prompting the second device 408 to initiate the packet data session. The CS signaling message may be communicated by the CS interface 404 associated with first device 402. In an aspect, the CS signaling message may identify the first device 402 as an IP communication enabled device. In another aspect, the CS signaling message may be based on an initiate CS call message. In such an aspect, a service option in the initiate CS call message may be set to indicate to the second device to set up the active packet data session rather than initiate a CS call. For example, the service option selection may be an unused service option may be selected, a new service option may be specified, etc. Further, the first device 402 may initially determine whether second device 408 has an active packet data session. In an aspect, upon a determination that the either the second device 408 does not have an active packet data session or that it is unknown whether the second device 408 has an active packet data session, the CS signaling message may be transmitted. Where the first device 402 determines that the second device has an active packet data session, then the devices may initiate IP based communications.

At act 416, upon receiving the CS signaling message from the first device 402, the second device 408 may bring up the data packet session and register for IP services. In an aspect, the second device 408 also intercepts the CS signaling message at the CS interface 410 prior to the second device 408 attempting to answer the CS call. In another aspect, where the second device has knowledge that the first device 402 does not support IP based communications, the second device 408 may initiate a CS call in response to receipt of the CS signaling message.

In an optional aspect, at act 418, the second device 408 may transmit another CS signaling message to the first device 402. In an aspect, the CS signaling message may include an indication prompting the first device 408 to initiate the packet data session. In another aspect, the CS signaling message may include an indication prompting the first device 408 to not initiate the packet data session. In such an aspect, upon receipt of the CS signaling message, the first device 402 may terminate the process. In an aspect, the CS signaling message may be transmitted from the CS interface 410 associated with the second device 408 to the CS interface 404 associated with the first device 402. In another aspect, the second device 408 may transmit a CS signaling message includes an indication that the target device is unavailable for the IP communication session. In such an aspect, the process may terminate.

At act 420, the first device 402 may bring up the data packet session and register for IP services. In an aspect, the first device 402 may perform the action in act 420 in response to transmission of the CS signaling message at act 414. In another aspect, the first device 402 may perform the action in act 420 in response to reception of the optional CS signaling message at act 418.

At act 422, an IP communication request message may be communicated between the first device 402 and the second device 408. In an aspect, the second device 408 transmits the IP communication request. In another aspect, the first device 402 transmits the IP communication request. In an aspect, the communications may be between the PS interface 406 associated with the first device 402 and the PS interface 412 associated with the second device 408.

At act 424, the device receiving the IP communication request may answer the request, and at act 426, IP based communications may be performed between the devices (402, 408). For example, the IP based communications may include, but are not limited to, a voice of IP (VoIP) call, a voice of LTE (VoLTE) call, a file transfer, media content communication, etc.

In another aspect, once the IP communication session is established, the first device 402 and/or second device 408 may invite other devices to join the IP communication session. Where any of the other invited devices either do not have an active packet session, or it is unknown whether they have an active packet session, the acts discussed above may be used to communicate with the other device or devices.

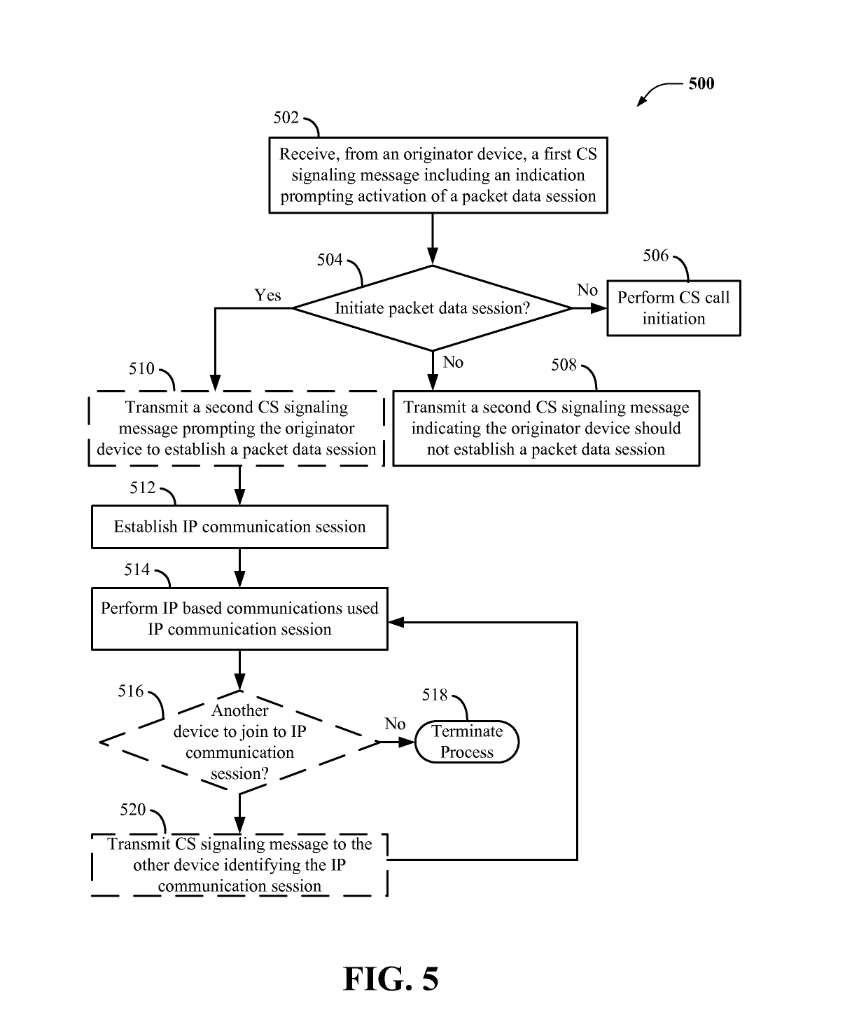

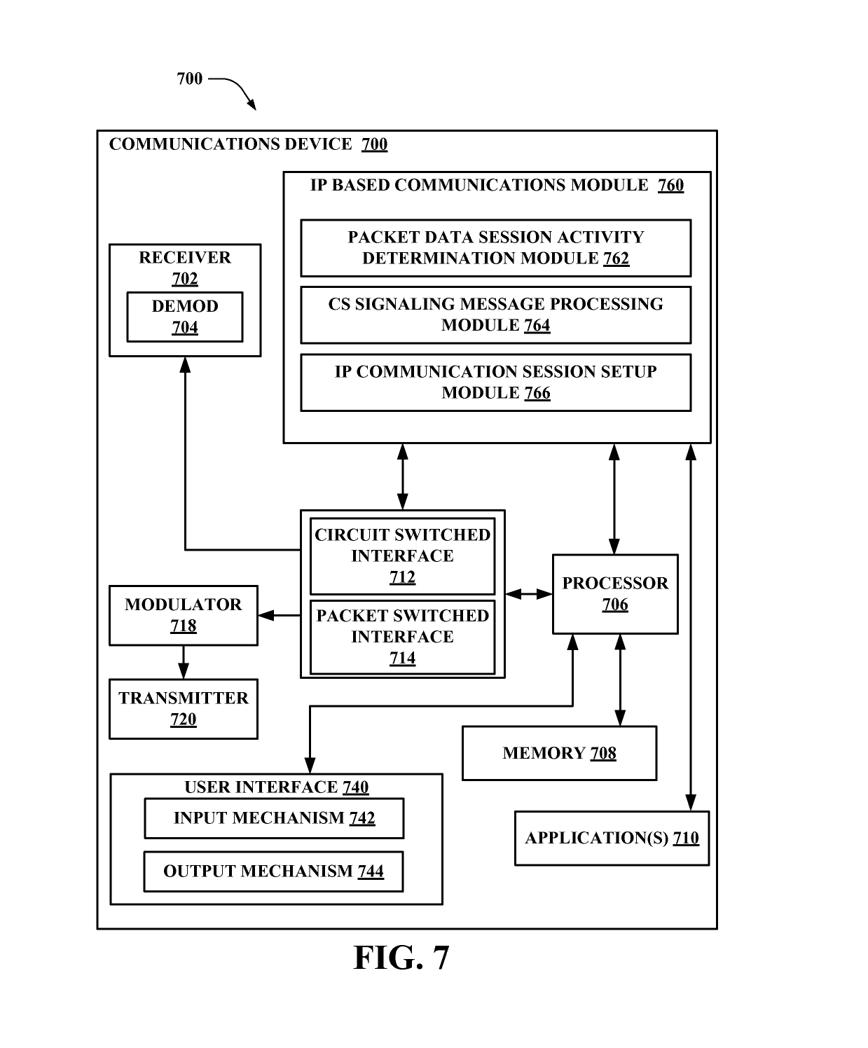

FIG. 5 is a flow chart 500 of a first method of wireless communication. The method may be performed by a UE (e.g., UE 302, UE 312, device 402, device 408). Further, the functionality described in the blocks depicted in flow chart 500 may be performed by various modules (760, 762, 764, 766) associated in the communications device 700 depicted in FIG. 7.

At block 502, a UE (e.g., a target device) may receive a first CS signaling message from an originator device including an indication prompting the receiving device to initiate a packet data session. In an aspect, the first CS signaling message may be an initiate CS call message. In an aspect, the initiate CS call message may prohibit the target device from initiating a CS call in response to receipt of the initiate CS call message. In such an aspect, the initiate CS call message may provide the indication through a service option. The service option may a reuse service option that is currently defined, such as the service options provided in Table 1, an unused service option, a service option specified for IP communication set up, etc. In an aspect, receiver 702 and circuit switched interface 712 may be configured to receive the CS signaling message.

At block 504, the UE may determine whether to initiate the packet data session in response to receipt of the first CS signaling message. In an aspect, IP based communications module 760 may intercept the first CS signaling message through circuit switched interface 712. Further, CS signaling message processing module 764 may interpret the received CS signaling message to determine any intended actions to be performed. Still further, packet data session activity determination module 762 may make the determination whether to initiate the packet data session.

In an aspect in which the UE decides, at block 504, to not to initiate the packet data session, then at block 506, the UE may perform a CS call initiation process. This response may occur where the target UE is not configured to support IP based communications, where the originator UE is not configured to support IP based communications, where the local network does not support IP based communications, where the UE decides not to communicate with the originator UE using IP based communications, etc. In an aspect, packet data session activity determination module 762 may make the determination not to initiate the packet data session, and the CS call initiation procedure may be performed using receiver 702 and/or transmitter 720 through circuit switched interface 712.

In another aspect in which the UE decides, at block 504, to not to initiate the packet data session, then at block 508, the UE may transmit a second CS signaling message indicating to the originator device that it should not establish a packet data session. Similar to as noted above, this response may occur where the UE is not configured to support IP based communications, where the local network does not support IP based communications, where the UE decides not to communicate with the originator UE using IP based communications, etc. In an aspect, packet data session activity determination module 762 may make the determination not to initiate the packet data session, and the CS signaling message processing module 764 may generate the second CS signaling message to be transmitted, via transmitter 720 and circuit switched interface 712, to the originator device.

Where the UE decides to initiate the packet data session at block 504, in an optional aspect at block 510, the UE may transmit a second CS signaling message to the originator device. In such an aspect, the second CS signaling message may include an indication prompting the originator device to initiate the packet data session. In an aspect, packet data session activity determination module 762 may make the determination to initiate the packet data session, and the CS signaling message processing module 764 may generate the second CS signaling message to be transmitted, via transmitter 720 and circuit switched interface 712, to the originator device.

At block 512, the UE may establish an IP communication session. In an aspect, the IP communication session may be established in response to communication of an IP connection request between the originator device and the target device. In such an aspect, the IP connection request me be sent by the target device and/or the originator device. In an aspect, IP communication session setup module 766 may setup the IP communication session. In such an aspect, IP communication session setup module 766 may transmit the IP connection request via packet switched interface 714 and transmitter 720. In another aspect, IP communication session setup module 766 may receive the IP connection request via packet switched interface 714 and receiver 702.

At block 514, the UE may perform IP based communications with the originator device using the established IP communication session. In an aspect, IP based communications may include, but are not limited to, a voice of IP (VoIP) call, a voice of LTE (VoLTE) call, a file transfer, media content communication, etc. In an aspect, IP based communications module 760 may support communication, via packet switched interface 714. Further, content communicated during the IP based communications may be provided by application 710.

In an optional aspect, at block 516, the UE may determine whether any additional devices may intend to join the IP communication session. In such an optional aspect, IP based communications module 760 may determine whether there are additional devices that may join the established IP communication session.

Where, in the optional aspect at block 516, the UE determines there are no additional devices intending to join the established IP communication session, then at block 518, the process may terminate. In another aspect, the UE may periodically check to determine if additional devices may join the IP communication session. In still another aspect, the UE may check based on occurrence of an event, to determine if additional devices may join the IP communication session. In such an optional aspect, the IP based communications module 760 may determine to terminate the process.

By contrast, where, in the optional aspect at block 516, the UE determines there is one or more additional devices intending to and/or available to join the established IP communication session, then at block 520, the UE may transmit a CS signaling message to the one or more additional devices identifying the IP communication session. In such an aspect, the CS signaling message may include an indication prompting the third device to initiate the packet data session upon a determination either that the third device does not have the active packet data session set up or that the target device is unable to determine that the third device has the active packet data session set up. In such an optional aspect, the CS signaling message processing module 764 may generate the CS signaling message for communication to the other devices, via circuit switched interface 712 and transmitter 720.

Thereafter, the process may return to block 514 and any connected devices may perform IP based communications via the established IP communication session.

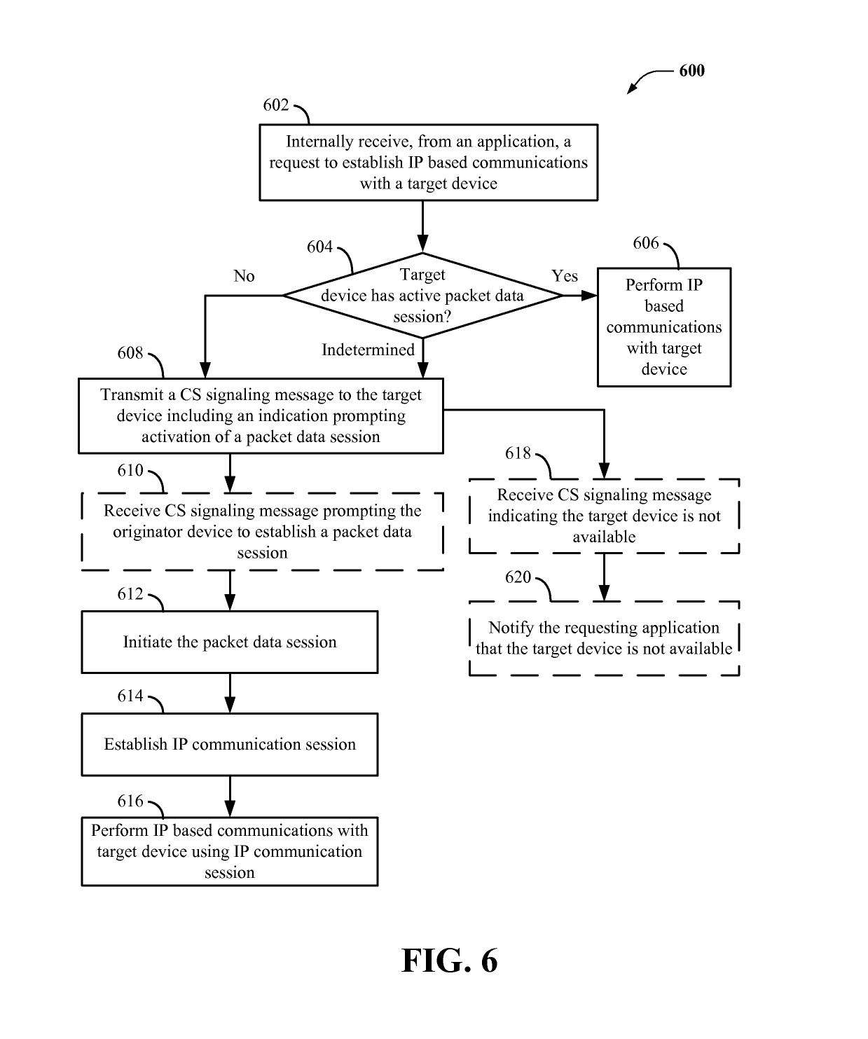

FIG. 6 is a flow chart 600 of a second method of wireless communication. The method may be performed by a UE (e.g., UE 302, UE 312, device 402, device 408). Further, the functionality described in the blocks depicted in flow chart 500 may be performed by various modules (760, 762, 764, 766) associated in the communications device 700 depicted in FIG. 7.

At block 602, a UE (e.g., an originator device) may internally receive a request to establish IP based communications with a target device. In an aspect, the request may internally be received from an application, a sensor, etc., associated with the UE. In an aspect, IP based communications module 760 may receive a request for IP based communications with a second device from application 710.

At block 604, the UE may determine whether the target device has an active packet data session. In an aspect, packet data session activity determination module 762 may attempt to determine whether the target device has an active packet data session.

Where the UE determines that the second device has an active packet session, then at block 606, the UE may perform IP based communications with the target device. In an aspect, IP based communications module 760 may facilitate communications between the target device an application 710, via packet switched interface 714, transmitter 720 and receiver 702.

Where the UE either determines that the target device does not have an active packet data session or is unable to determine whether the target device has an active packet data session, then at block 608, the UE ay transmit a first CS signaling message to the target device includes an indication prompting the target device to initiate the packet data session. In an aspect, the CS signaling message processing module 764 may generate the CS signaling message for communication to the target device, via circuit switched interface 712 and transmitter 720.

In an optional aspect, at block 610, the UE may receive a second CS signaling message including an indication prompting the originator device to initiate the packet data session. In an aspect, the CS signaling message processing module 764 may process the CS signaling message that is received via receiver 702 and circuit switched interface 712.

In another optional aspect, at block 618, the UE may receive a second CS signaling message indicating that the target device is not available. This CS message may be received when the target UE is not configured to support IP based communications, when the local network for the target UE does not support IP based communications, when the target UE decides not to communicate with the originator UE using IP based communications, etc. In an aspect, CS signaling message processing module 764 may process the received CS signaling message via receiver 702 and circuit switched interface 712, and packet data session activity determination module 762 may make the determination not to initiate the packet data session.

In such an optional aspect, at block 620, the UE may send an internal notification to the requesting application that the target UE is unavailable. In an aspect, the IP based communications module 760 may provide the notification to the application 710.

At block 612, the UE may initiate the packet data session. In an aspect, the UE may initiate the packet data session in response to transmission of the first CS signaling message. In another aspect, the UE may initiate the packet data session in response to reception of the second CS signaling message (in optional block 610).

At block 614, the UE may establish an IP communication session. In an aspect, the UE may establish, using a packet switched (PS) interface, the IP communication session in response to communication of an IP connection request between the originator device and the target device. In an aspect, the IP connection request may be transmitted by the UE. In another aspect, the IP request may be received from the target UE. In an aspect, IP communication session setup module 766 may setup the IP communication session. In such an aspect, IP communication session setup module 766 may transmit the IP connection request via packet switched interface 714 and transmitter 720. In another aspect, IP communication session setup module 766 may receive the IP connection request via packet switched interface 714 and receiver 702.

At block 616, the UE may perform IP based communications with the target device. In an aspect, one or more additional devices may join the IP communication session and perform IP based communications. In an aspect, IP based communications may include, but are not limited to, a voice of IP (VoIP) call, a voice of LTE (VoLTE) call, a file transfer, media content communication, etc. In an aspect, IP based communications module 760 may support communication, via packet switched interface 714. Further, content communicated during the IP based communications may be provided by application 710.

FIG. 7 illustrates an example architecture of a communications device 700. As depicted in FIG. 7, communications device 700 comprises receiver 702 that receives a signal from, for instance, a receive antenna (not shown), performs typical actions on (e.g., filters, amplifies, downconverts, etc.) the received signal, and digitizes the conditioned signal to obtain samples. Receiver 702 can comprise a demodulator 704 that can demodulate received symbols and provide them to processor 706 for channel estimation. Processor 706 can be a processor dedicated to analyzing information received by receiver 702 and/or generating information for transmission by transmitter 720, a processor that controls one or more components of communications device 700, and/or a processor that both analyzes information received by receiver 702, generates information for transmission by transmitter 720, and controls one or more components of communications device 700. Further, signals may be prepared for transmission by transmitter 720 through modulator 718 which may modulate the signals processed by processor 706.

Still further, communications device 700 may be configured to communicate using packet switched communications (e.g., via EPS 100) and/or circuit switched communications (e.g., via circuit switched system 130). Communications with a circuit switched communications system may be facilitated through circuit switched interface 712. Communications with a packet switched communications system may be facilitated through packet switched interface 714.

Communications device 700 can additionally comprise memory 708 that is operatively coupled to various components, such as but not limited processor 706 and that can store data to be transmitted, received data, information related to available channels, TCP flows, data associated with analyzed signal and/or interference strength, information related to an assigned channel, power, rate, or the like, and any other suitable information for assisting in IP communication session connection establishment.

Processor 706, receiver 702, transmitter 720, circuit switched interface 712, packet switched interface 714 and/or IP based communications module 760 can provide means for receiving, by a CS interface associated with a target device, a first CS signaling message from an originator device, means for determining whether to initiate the packet data session in response to receipt of the first CS signaling message, and means for establishing, using a PS interface associated with the target device, an IP communication session in response to communication of an IP connection request between the originator device and the target device upon a determination to initiate the packet data session. In an aspect, the first CS signaling message may include an indication prompting the target device to initiate a packet data session. Further, processor 706, receiver 702, transmitter 720, circuit switched interface 712, packet switched interface 714 and/or IP based communications module 760 can provide means for receiving, internally from an application associated with an originator device, a request to establish an IP communication session with a target device, means for determining whether the target device has an active packet data session set up, and means for transmitting, by a CS interface associated with the originator device, a first CS signaling message upon a determination either that the target device does not have the active packet data session set up or that the originator device is unable to determine that the target device has the active packet data session set up. In an aspect, the first CS signaling message may include an indication prompting the target device to initiate the packet data session.

It will be appreciated that data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 708 of the subject systems and methods may comprise, without being limited to, these and any other suitable types of memory.

Communications device 700 may include user interface 740. User interface 740 may include input mechanisms 742 for generating inputs into communications device 700, and output mechanism 744 for generating information for consumption by the user of the communications device 700. For example, input mechanism 742 may include a mechanism such as a key or keyboard, a mouse, a touch-screen display, a microphone, etc. Further, for example, output mechanism 744 may include a display, an audio speaker, a haptic feedback mechanism, a Personal Area Network (PAN) transceiver etc. In the illustrated aspects, the output mechanism 744 may include a display operable to present media content that is in image or video format or an audio speaker to present media content that is in an audio format.

In another aspect, communications device 700 may include IP based communications module 760. As described above with reference to FIGS. 5 and 6, IP based communications module 760 may include packet data session activity determination module 762, CS signaling message processing module 764, and IP communication session setup module 766. IP based communications module 760 facilities communication of content between application 710, sensors, etc., and other devices. In another aspect, IP based communications module 760 may be operable to perform any of the acts and/or blocks described with respect to FIGS. 4-6.

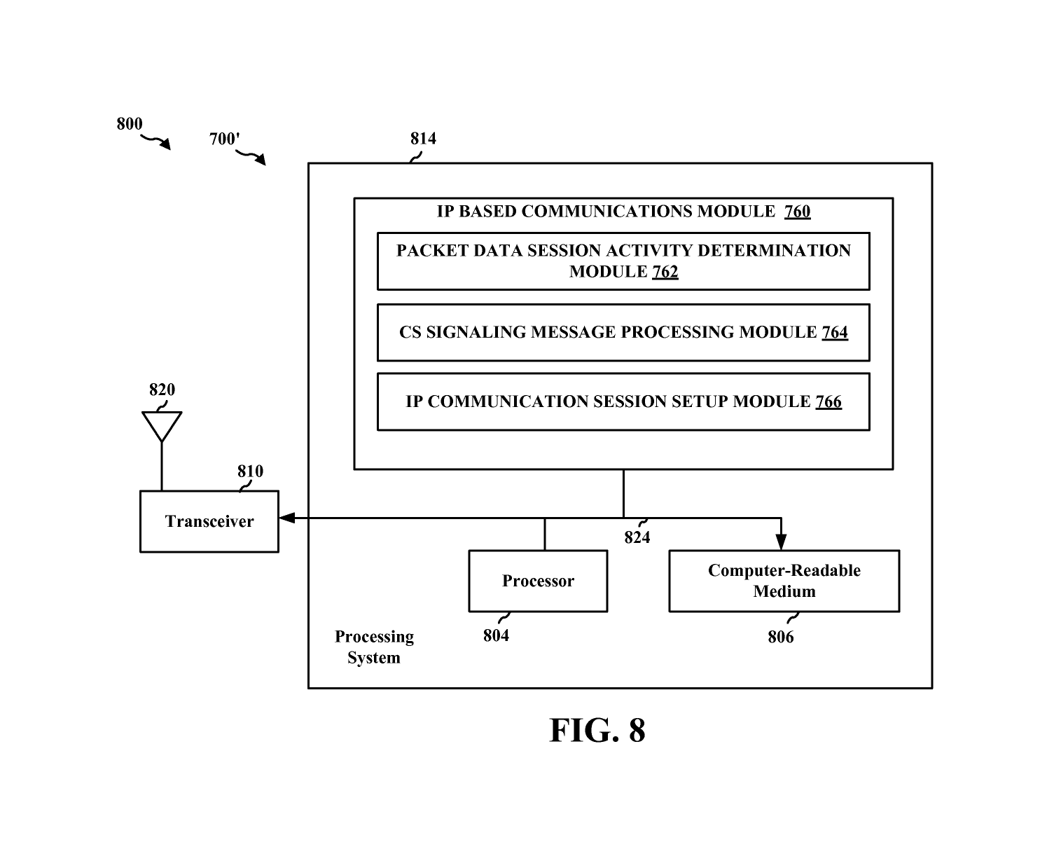

FIG. 8 is a diagram 800 illustrating an example of a hardware implementation for an apparatus 700′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 804, the modules 760, 762, 764, 766, and the computer-readable medium 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The processing system 814 includes a processor 804 coupled to a computer-readable medium 806. The processor 804 is responsible for general processing, including the execution of software stored on the computer-readable medium 806. The software, when executed by the processor 804, causes the processing system 814 to perform the various functions described supra for any particular apparatus. The computer-readable medium 806 may also be used for storing data that is manipulated by the processor 804 when executing software. The processing system further includes at least one of the modules 760, 762, 764, and 766. The modules may be software modules running in the processor 804, resident/stored in the computer-readable medium 806, one or more hardware modules coupled to the processor 804, or some combination thereof. The processing system 814 may be a component of the communications device 700 and may include the memory 708 and/or at least one of transmitter 720, receiver 702, circuit switched interface 712, packet switched interface 714, IP based communications module 760, and processor 706.

In one configuration, the apparatus 700/700′ for wireless communication includes means for receiving, by a CS interface associated with a target device, a first CS signaling message from an originator device, means for determining whether to initiate the packet data session in response to receipt of the first CS signaling message, and means for establishing, using a PS interface associated with the target device, an IP communication session in response to communication of an IP connection request between the originator device and the target device upon a determination to initiate the packet data session. In an aspect, the first CS signaling message may include an indication prompting the target device to initiate a packet data session. In an aspect, the apparatus 700/700′ may further include means for performing IP based communications with the originator device using the IP communication session. In an aspect, the apparatus 700/700′ may include means for transmitting a second CS signaling message to the originator device. In such an aspect, the second CS signaling message may include an indication prompting the originator device to initiate the packet data session. In an aspect, the apparatus 700/700′ may include means for transmitting a second CS signaling message to the originator device, wherein the second CS signaling message includes an indication prompting the originator device to not initiate the packet data session, upon a determination not to initiate the packet data session. In such an aspect, the apparatus 700/700′ may include means for performing CS call initiation, upon a determination that the originator device is not configured to support IP based communications based at least in part on an originator device identifier. In an aspect, the apparatus 700/700′ may include means for determining whether a third device has an active packet session set up to join the established IP communication session. In such an aspect, the apparatus 700/700′ may include means for transmitting, by the CS interface associated with target device, a third CS signaling message upon a determination either that the third device does not have the active packet data session set up or that the target device is unable to determine that the third device has the active packet data session set up. In an aspect, the third CS signaling message may include an indication prompting the third device to initiate the packet data session. Further, in such an aspect, the apparatus 700/700′ may include means for performing IP based communications with the originator device and the third device using the IP communication session.

In another configuration, the apparatus 700/700′ for wireless communication includes means for receiving, internally from an application associated with an originator device, a request to establish an IP communication session with a target device, means for determining whether the target device has an active packet data session set up, and means for transmitting, by a CS interface associated with the originator device, a first CS signaling message upon a determination either that the target device does not have the active packet data session set up or that the originator device is unable to determine that the target device has the active packet data session set up. In an aspect, the first CS signaling message may include an indication prompting the target device to initiate the packet data session. In an aspect, the apparatus 700/700′ may further include means for initiating the packet data session. In an aspect, the apparatus 700/700′ may further include means for establishing the IP communication session with the target device, and means for performing IP based communications with the target device using the IP communication session. In an aspect, the apparatus 700/700′ means for receiving may be further configured to receive a second CS signaling message. In an aspect, the second CS signaling message may include an indication prompting the originator device to initiate the packet data session, and the packet data session may be initiated in response to the reception of the second CS signaling message. In an aspect, the apparatus 700/700′ means for receiving may be further configured to receive a second CS signaling message. In an aspect, the second CS signaling message may include an indication that the target device is unavailable for the IP communication session. In such an aspect, the apparatus 700/700′ may include means for sending a notice to the application indicating that the target device is unavailable. In such an aspect, the apparatus 700/700′ means for establishing may be further configured to establish, by a PS interface associated with the originator device, the IP communication session in response to communication of an IP connection request between the originator device and the target device. In an aspect, the apparatus 700/700′ may further include means for performing IP based communications with the target device and a third device using the IP communication session. In an aspect, the third device may be connected to the IP communication session by the target device.

The aforementioned means may be one or more of the aforementioned modules of the communications device 700 and/or the processing system 814 of the apparatus 700′ configured to perform the functions recited by the aforementioned means. As described supra, the processing system 814 may include the transmitter 720, receiver 702, circuit switched interface 712, packet switched interface 714, IP based communications module 760, and processor 706. As such, in one configuration, the aforementioned means may be the transmitter 720, receiver 702, circuit switched interface 712, packet switched interface 714, IP based communications module 760, and processor 706 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of communications, comprising:
receiving, by a circuit switched (CS) interface associated with a target device, a first CS signaling message from an originator device, wherein the first CS signaling message includes an indication prompting the target device to initiate a packet data session;
determining whether to initiate the packet data session in response to receipt of the first CS signaling message; and
establishing, using a packet switched (PS) interface associated with the target device, an internet protocol (IP) communication session in response to communication of an IP connection request between the originator device and the target device upon a determination to initiate the packet data session.

2. The method of claim 1, further comprising:
performing IP based communications with the originator device using the IP communication session.

3. The method of claim 1, further comprising:
transmitting a second CS signaling message to the originator device, wherein the second CS signaling message includes an indication prompting the originator device to initiate the packet data session.

4. The method of claim 1, further comprising:
transmitting a second CS signaling message to the originator device, wherein the second CS signaling message includes an indication prompting the originator device to not initiate the packet data session, upon a determination not to initiate the packet data session.

5. The method of claim 1, wherein the first CS signaling message includes an originator device identifier, and further comprising:
performing CS call initiation, upon a determination that the originator device is not configured to support IP based communications based at least in part on the originator device identifier.

6. The method of claim 1, wherein the first CS signaling message is an initiate CS call message, and wherein the indication is included in a service option in the initiate CS call message.

7. The method of claim 6, wherein the indication further comprises prohibiting the target device from initiating a CS call in response to receipt of the initiate CS call message.

8. The method of claim 6, wherein the service option comprises an unused service option, or a service option specified for IP communication set up.

9. The method of claim 1, wherein the communication of the IP connection request comprises transmitting the IP communication request to the originator device.

10. The method of claim 1, wherein the communication of the IP connection request comprises receiving the IP communication request from the originator device.

11. The method of claim 2, wherein the IP based communications comprise at least one of: a voice of IP (VoIP) call, a voice of LTE (VoLTE) call, a file transfer, or media content communication.

12. The method of claim 1, further comprising:
determining whether a third device has an active packet data session set up to join the established IP communication session; and
transmitting, by the CS interface associated with the target device, a third CS signaling message upon a determination either that the third device does not have the active packet data session set up or that the target device is unable to determine that the third device has the active packet data session set up, wherein the third CS signaling message includes an indication prompting the third device to initiate the packet data session.

13. The method of claim 12, further comprising:
performing IP based communications with the originator device and the third device using the IP communication session.

14. A method of communications, comprising:
receiving, internally from an application associated with an originator device, a request to establish an internet protocol (IP) communication session with a target device;
determining whether the target device has an active packet data session set up; and
transmitting, by a circuit switched (CS) interface associated with the originator device, a first CS signaling message upon a determination either that the target device does not have the active packet data session set up or that the originator device is unable to determine that the target device has the active packet data session set up, wherein the first CS signaling message includes an indication prompting the target device to initiate a packet data session.

15. The method of claim 14, further comprising:
initiating the packet data session.

16. The method of claim 15, further comprising:
establishing the IP communication session with the target device; and
performing IP based communications with the target device using the IP communication session.

17. The method of claim 15, wherein the packet data session is initiated in response to the transmission of the first CS signaling message.

18. The method of claim 15, further comprising:
receiving a second CS signaling message, wherein the second CS signaling message includes an indication prompting the originator device to initiate the packet data session, and wherein the packet data session is initiated in response to the reception of the second CS signaling message.

19. The method of claim 14, furthering comprising:
receiving a second CS signaling message, wherein the second CS signaling message includes an indication that the target device is unavailable for the IP communication session; and
sending a notice to the application indicating that the target device is unavailable.

20. The method of claim 16, wherein the establishing further comprises:
establishing, by a packet switched (PS) interface associated with the originator device, the IP communication session in response to communication of an IP connection request between the originator device and the target device.

21. The method of claim 20, wherein the communication of the IP connection request comprises transmitting the IP communication request to the target device.

22. The method of claim 20, wherein the communication of the IP connection request comprises receiving the IP communication request from the target device.

23. The method of claim 16, wherein the IP based communications comprise at least one of: a voice of IP (VoIP) call, a voice of LTE (VoLTE) call, a file transfer, or media content communication.

24. The method of claim 15, wherein the performing further comprises:
performing IP based communications with the target device and a third device using the IP communication session, wherein the third device is connected to the IP communication session by the target device.

25. An apparatus for wireless communication, comprising:
means for receiving, by a circuit switched (CS) interface associated with a target device, a first CS signaling message from an originator device, wherein the first CS signaling message includes an indication prompting the target device to initiate a packet data session;
means for determining whether to initiate the packet data session in response to receipt of the first CS signaling message; and
means for establishing, using a packet switched (PS) interface associated with the target device, an internet protocol (IP) communication session in response to communication of an IP connection request between the originator device and the target device upon a determination to initiate the packet data session.

26. An apparatus for wireless communication, comprising:
means for receiving, internally from an application associated with an originator device, a request to establish an internet protocol (IP) communication session with a target device;
means for determining whether the target device has an active packet data session set up; and
means for transmitting, by a circuit switched (CS) interface associated with the originator device, a first CS signaling message upon a determination either that the target device does not have the active packet data session set up or that the originator device is unable to determine that the target device has the active packet data session set up, wherein the first CS signaling message includes an indication prompting the target device to initiate a packet data session.

27. A computer program product, comprising:
a computer-readable medium comprising code for:
receiving, by a circuit switched (CS) interface associated with a target device, a first CS signaling message from an originator device, wherein the first CS signaling message includes an indication prompting the target device to initiate a packet data session;
determining whether to initiate the packet data session in response to receipt of the first CS signaling message; and
establishing, using a packet switched (PS) interface associated with the target device, an internet protocol (IP) communication session in response to communication of an IP connection request between the originator device and the target device upon a determination to initiate the packet data session.

28. A computer program product, comprising:
a computer-readable medium comprising code for:
receiving, internally from an application associated with an originator device, a request to establish an internet protocol (IP) communication session with a target device;
determining whether the target device has an active packet data session set up; and
transmitting, by a circuit switched (CS) interface associated with the originator device, a first CS signaling message upon a determination either that the target device does not have the active packet data session set up or that the originator device is unable to determine that the target device has the active packet data session set up, wherein the first CS signaling message includes an indication prompting the target device to initiate a packet data session.

29. An apparatus for wireless communication, comprising:
a processing system configured to:
receive, by a circuit switched (CS) interface associated with a target device, a first CS signaling message from an originator device, wherein the first CS signaling message includes an indication prompting the target device to initiate a packet data session;
determine whether to initiate the packet data session in response to receipt of the first CS signaling message; and
establish, using a packet switched (PS) interface associated with the target device, an internet protocol (IP) communication session in response to communication of an IP connection request between the originator device and the target device upon a determination to initiate the packet data session.

30. The apparatus of claim 29, wherein the processing system is further configured to:
perform IP based communications with the originator device using the IP communication session.

31. The apparatus of claim 29, wherein the processing system is further configured to:
transmit a second CS signaling message to the originator device, wherein the second CS signaling message includes an indication prompting the originator device to initiate the packet data session.

32. The apparatus of claim 29, wherein the processing system is further configured to:
transmit a second CS signaling message to the originator device, wherein the second CS signaling message includes an indication prompting the originator device to not initiate the packet data session, upon a determination not to initiate the packet data session.

33. The apparatus of claim 29, wherein the first CS signaling message includes an originator device identifier, and wherein the processing system is further configured to:
perform CS call initiation, upon a determination that the originator device is not configured to support IP based communications based at least in part on the originator device identifier.

34. The apparatus of claim 29, wherein the first CS signaling message is an initiate CS call message, and wherein the indication is included in a service option in the initiate CS call message.

35. The apparatus of claim 34, wherein the processing system is further configured to prohibit the target device from initiating a CS call in response to receipt of the initiate CS call message.

36. The apparatus of claim 34, wherein the service option comprises an unused service option, or a service option specified for IP communication set up.

37. The apparatus of claim 29, wherein the processing system is further configured to transmit the IP communication request to the originator device.

38. The apparatus of claim 29, wherein the processing system is further configured to receive the IP communication request from the originator device.

39. The apparatus of claim 30, wherein the IP based communications comprise at least one of: a voice of IP (VoIP) call, a voice of LTE (VoLTE) call, a file transfer, or media content communication.

40. The apparatus of claim 29, wherein the processing system is further configured to:
determine whether a third device has an active packet data session set up to join the established IP communication session; and
transmit, by the CS interface associated with the target device, a third CS signaling message upon a determination either that the third device does not have the active packet data session set up or that the target device is unable to determine that the third device has the active packet data session set up, wherein the third CS signaling message includes an indication prompting the third device to initiate the packet data session.

41. The apparatus of claim 40, wherein the processing system is further configured to:
perform IP based communications with the originator device and the third device using the IP communication session.

42. An apparatus for wireless communication, comprising:
a processing system configured to:
receive, internally from an application associated with an originator device, a request to establish an internet protocol (IP) communication session with a target device;
determine whether the target device has an active packet data session set up; and
transmit, by a circuit switched (CS) interface associated with the originator device, a first CS signaling message upon a determination either that the target device does not have the active packet data session set up or that the originator device is unable to determine that the target device has the active packet data session set up, wherein the first CS signaling message includes an indication prompting the target device to initiate a packet data session.

43. The apparatus of claim 42, wherein the processing system is further configured to:
initiate the packet data session.

44. The apparatus of claim 43, wherein the processing system is further configured to:
establish the IP communication session with the target device; and
perform IP based communications with the target device using the IP communication session.

45. The apparatus of claim 43, wherein the packet data session is initiated in response to the transmission of the first CS signaling message.

46. The apparatus of claim 43, wherein the processing system is further configured to:
receive a second CS signaling message, wherein the second CS signaling message includes an indication prompting the originator device to initiate the packet data session, and wherein the packet data session is initiated in response to the reception of the second CS signaling message.

47. The apparatus of claim 42, wherein the processing system is further configured to:
receive a second CS signaling message, wherein the second CS signaling message includes an indication that the target device is unavailable for the IP communication session; and
send a notice to the application indicating that the target device is unavailable.

48. The apparatus of claim 44, wherein the processing system is further configured to:
establish, by a packet switched (PS) interface associated with the originator device, the IP communication session in response to communication of an IP connection request between the originator device and the target device.

49. The apparatus of claim 48, wherein the communication of the IP connection request comprises transmitting the IP communication request to the target device.

50. The apparatus of claim 48, wherein the communication of the IP connection request comprises receiving the IP communication request from the target device.

51. The apparatus of claim 44, wherein the IP based communications comprise at least one of: a voice of IP (VoIP) call, a voice of LTE (VoLTE) call, a file transfer, or media content communication.

52. The apparatus of claim 43, wherein the processing system is further configured to:
perform IP based communications with the target device and a third device using the IP communication session, wherein the third device is connected to the IP communication session by the target device.
